(19) United States
(12) Patent Application Publication
(10) Pub. No.: US 2017/0227188 A1
(43) Pub. Date: Aug. 10, 2017

(54) DISPLAY DEVICE HAVING LIGHT GUIDE PLATE WITH A CURVED SURFACE

(71) Applicant: WUHAN CHINA STAR OPTOELECTRONICS TECHNOLOGY CO., LTD., Wuhan, Hubei (CN)

(72) Inventor: Jie ZENG, Wuhan, Hubei (CN)

(21) Appl. No.: 14/905,516

(22) PCT Filed: Dec. 31, 2015
(86) PCT No.: PCT/CN2015/100225

§ 371 Date: Jan. 15, 2016

(30) Foreign Application Priority Data
Oct. 27, 2015 (CN) 201510706182.9

(51) Int. Cl. F21V 3/02; F21V 3/04

(52) U.S. Cl. CPC F21V 3/02; F21V 3/049; F21Y 2107/10

(57) ABSTRACT

The present invention provides a display device having a direct-lit type light guide plate with a curved surface, including a light guide plate with a curved surface. The curved surface of the light guide plate with a curved surface is formed by a plurality of strip-shaped sections connected in parallel with each other. A strip-shaped groove parallel and connected to the strip-shaped sections is formed between each two of the strip-shaped sections. In addition, a plurality of direct-type light sources are included, the direct-type light sources arranged in more than one row, and each row of the direct type lights corresponds to each of the strip-shaped grooves.

### FIELD OF THE INVENTION

The present invention relates to a display device having a light guide plate with a curved surface, and particularly to a curved-surface display device, which is provided with direct-type light sources and has uniform light.

### BACKGROUND OF THE INVENTION

With the rapid development of display technology, display size is increasing. When people watch the plane display, since the distances between the respective displaying parts of the display and the human eyes are not equal, an image displayed by a pure flat display is actually “distorted”, this phenomenon is particularly serious especially when facing a big screen.

As a result, recently curved-surface displays have been developed, the curvature of the display screen having a curved surface is substantially equal to the curvature of the retina of human eyes, so when a user directly in front of the display is watching the screen of the display having the curved surface, a distance between a center region of the curved-surface display in a horizontal direction to the human eyes is substantially equal to a distance between an edge region of the curved-surface display in a horizontal direction. In addition, distances between the user and the respective pixels are the same when the user watches TV. This makes the image intuitively map to the brain at the same angle. A better viewing angle can be achieved at each of the left side and the right side of the arc curved surface display, thus the user can experience viewing which is more natural, more comfortable, less pressure on the brain, and with more outstanding presence, this is an all new experience of viewing.

Generally, a display panel in the curved surface display is bent to a certain radian, and cooperates with the direct-type backlight manner of the curved surface to form a curved surface display device. Because the light is transmitted along a straight line, when the display panel is bent, there will be some risk, such as uneven screen light.

The present invention provides a light guide plate with a curved surface having a direct-type light source and a display device thereof, to prevent the risk like uneven screen light mentioned above.

### SUMMARY OF THE INVENTION

According to an embodiment of the present invention, a display device having a direct-lit type light guide plate with a curved surface is provided, and the display device includes a light guide plate with a curved surface, the curved surface being formed by a plurality of strip-shaped sections connected in parallel with each other, and a strip-shaped groove parallel and connected to the strip-shaped sections being formed between each two of the strip-shaped sections; and a plurality of direct-type light sources, the direct-type light sources arranged in more than one row, and each row of the direct type lights corresponding to each of the strip-shaped grooves.

According to an embodiment of the present invention, each of the strip-shaped sections is a strip-shaped plane, there is a plurality of net spots distributed on each strip-shaped plane.

According to another embodiment of the present invention, each of the strip-shaped sections is a polygon curved surface, each of the polygon curved surfaces is formed by a plurality of strip-shaped planes connected in parallel with each other, and there is a plurality of net spots distributed on each strip-shaped plane.

According to yet another embodiment of the present invention, each of the strip-shaped sections is a strip-shaped circular surface, each of the strip-shaped circular surfaces is formed by a plurality of strip-shaped planes connected in parallel with each other, and there is a plurality of net spots distributed on each strip-shaped plane.

The present invention has an advantage that each rectangular light guide plate net spot can be designed according to the light guide plate net spot displayed on plane, the difficulty of designing the net spot is greatly reduced, and processing the net spot on the plane is much easier than on the curved surface, each polygon or circular structure corresponds to a row of direct-type light sources, thus the light of the curved surface display screen is more uniform.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a structural diagram of a display device having a light guide plate with a curved surface according to an embodiment of the present invention;

FIG. 2 is a structural lateral view of a display device having a light guide plate with a curved surface according to the embodiment of the present invention;

FIG. 3 is a diagram of a light guide plate with a curved surface according to the embodiment of the present invention;

FIG. 4 is a diagram of a light guide plate with a curved surface according to another embodiment of the present invention;

FIG. 5 is a diagram of a light guide plate with a curved surface according to the another embodiment of the present invention;

FIG. 6 is a diagram of a light guide plate with a curved surface according to yet another embodiment of the present invention;

FIG. 7 is a diagram of a light guide plate with a curved surface according to the yet another embodiment of the present invention; and

FIG. 8 is a structural lateral view of the assembled display device having the light guide plate with a curved surface in FIG. 1.

### DETAILED DESCRIPTION OF THE PREFERRED EMBODIMENTS

As used in this specification the term “embodiment” means an instance, example, or illustration. In addition, for the articles in this specification and the appended claims, “a” or “an” in general can be interpreted as “one or more” unless specified otherwise or clear from context to determine the singular form.

In the drawings, the same reference numerals denote units with similar structures.

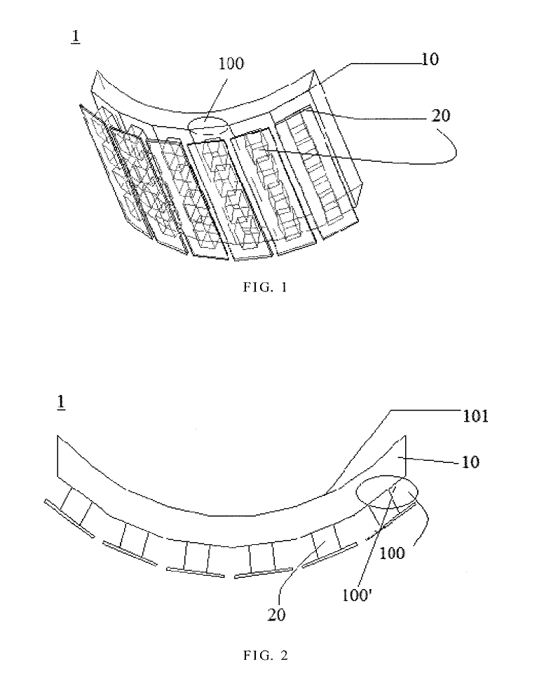

As shown in FIG. 1, FIG. 1 is a structural diagram of a display device 1 having a light guide plate with a curved surface 10 according to an embodiment of the present invention. The display device 1 includes a light guide plate with a curved surface 10, wherein a curved surface of the light guide plate with a curved surface is formed by a plurality of strip-shaped sections 100 connected in parallel with each other, and a strip-shaped groove 112 parallel and connected to the strip-shaped sections 100 is disposed between each two of the strip-shaped sections 100. A plurality of direct-type light sources 20 are arranged in more than one row, and each row of the direct type lights 20 corresponds to one of the strip-shaped grooves 112. Each of the strip-shaped sections 100 is a strip-shaped plane 100′, there is a plurality of net spots (not shown) distributed on each strip-shaped plane 100′.

Please refer to FIG. 2, which is a structural lateral view of the display device 1 in FIG. 1, the back of the light guide plate 10 shows up as an circular arch 101, and each strip-shaped plane 100′ corresponds to a row of direct-type light sources 20.

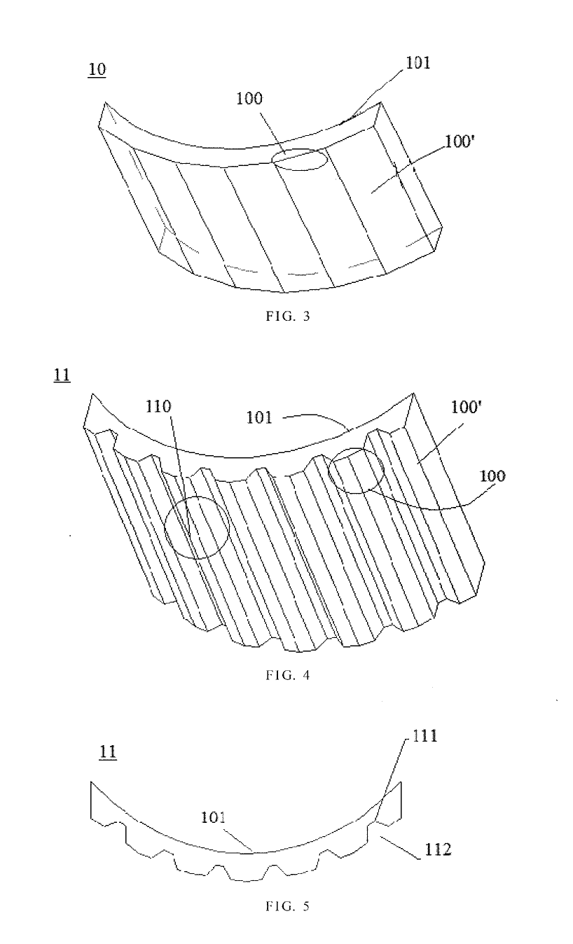

Please refer to FIG. 3, which is a diagram of a light guide plate with a curved surface 10 in FIG. 1, the back of the light guide plate 10 shows up as a circular arch 101.

FIG. 4 is a diagram of a light guide plate with a curved surface according to another embodiment of the present invention, the curved surface of the light guide plate with a curved surface 11 is formed by a plurality of strip-shaped sections 100, each of the strip-shaped sections 100 is a polygon curved surface 110, each polygon curved surface 110 is formed by a plurality of strip-shaped planes 100′ connected in parallel with each other, there are a plurality of net spots distributed on each strip-shaped plane 100′ (not shown), the back of the light guide plate 11 shows up as an circular arch 101.

Please refer to FIG. 5, which is a structural lateral view of the light guide plate with a curved surface 11 in FIG. 4, the back of the light guide plate 11 shows up as an circular arch 101, and each strip-shaped plane 100′ corresponds to a row of direct-type light sources 20, and each polygon light-scattering mouth 111 is disposed between each two of the strip-shaped sections 100, and corresponding to a row of direct-type light sources 20, wherein the strip-shaped groove 112 is parallel and connected to the strip-shaped section 100.

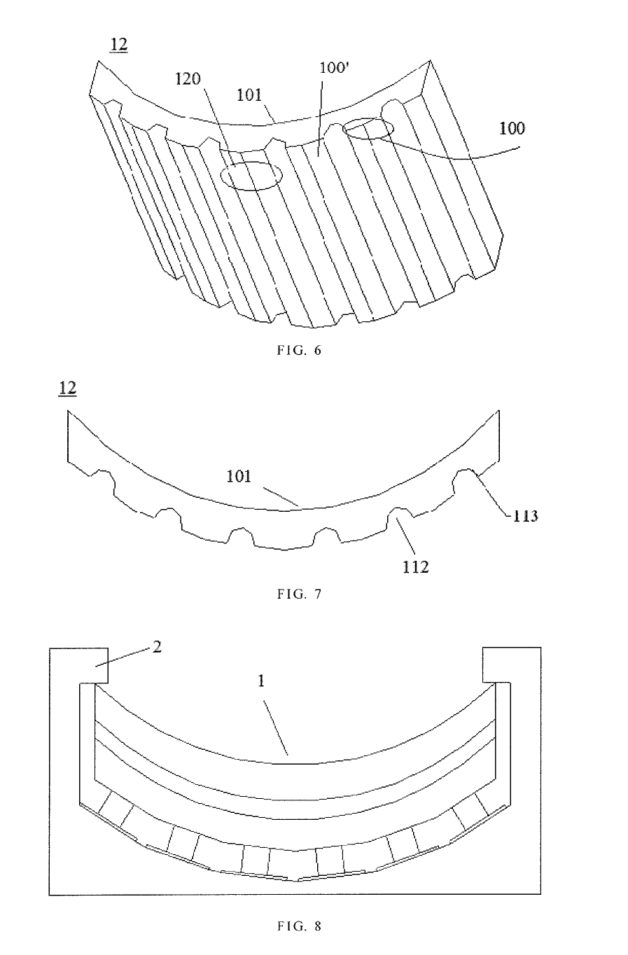

FIG. 6 is a diagram of a light guide plate with a curved surface 12 according to yet another embodiment of the present invention, the curved surface of the light guide plate with a curved surface 12 is formed by a plurality of strip-shaped sections 100 connected in parallel with each other, the plurality of strip-shaped sections 100 are a plurality of strip-shaped circular surfaces 120, each strip-shaped circular surface 120 is formed by two strip-shaped planes 100′ connected in parallel with each other, the number of the strip-shaped planes 100′ here is only an example, and is not used to limit the present invention, there is a plurality of net spots on each strip-shaped plane 100′ (not shown), the back of the light guide plate 12 shows up as an circular arch 101.

Please refer to FIG. 7, which is a structural lateral view of the light guide plate with a curved surface 12 in FIG. 6, the back of the light guide plate 12 shows up as an circular arch 101, and each polygon light-scattering mouth 113 is disposed between each two of the strip-shaped sections 100, and corresponding to a row of direct-type light sources 20, wherein the strip-shaped groove 112 is parallel and connected to the strip-shaped section 100.

Please refer to FIG. 8, which is a structural lateral view of the assembled display device having the light guide plate with a curved surface in FIG. 1, wherein an out case 2 is added to the display device 1.

The present invention has an advantage that each rectangular light guide plate net spot can be designed according to the light guide plate net spot displayed on plane, the difficulty of designing the net spot is greatly reduced, and processing the net spot on the plane is much easier than on the curved surface, each polygon or circular structure corresponds to a row of direct-type light sources, thus the light of the curved surface display screen is more uniform.

In summary, although the preferable embodiments of the present invention have been disclosed above, the embodiments are not intended to limit the present invention. A person of ordinary skill in the art, without departing from the spirit and scope of the present invention, can make various modifications and variations. Therefore, the scope of the invention is defined in the claims.

What is claimed is:

1. A display device having a direct-lit type light guide plate with a curved surface, comprising:
a light guide plate with a curved surface, the curved surface being formed by a plurality of strip-shaped sections connected in parallel with each other, and a strip-shaped groove parallel and connected to the strip-shaped sections being formed between each two of the strip-shaped sections; and
a plurality of direct light sources being arranged in more than one row, and each row of the direct light sources being corresponding to one of the strip-shaped grooves;
wherein the curved guide plate has a plurality of net spots distributed on a surface of the light guide plate with a curved surface.

2. A display device having a direct-lit type light guide plate with a curved surface, comprising:
a light guide plate with a curved surface, the curved surface of the light guide plate with a curved surface being formed by a plurality of strip-shaped sections connected in parallel with each other, and a strip-shaped groove parallel and connected to the strip-shaped sections being formed between each two of the strip-shaped sections; and
a plurality of direct-type light sources, the direct-type light sources being arranged in more than one row, and each row of the direct type lights corresponding to each of the strip-shaped grooves.

3. The display device of claim 2, wherein each of the strip-shaped sections is a strip-shaped plane.

4. The display device of claim 3, wherein there is a plurality of net spots distributed on each strip-shaped plane.

5. The display device of claim 2, wherein each of the strip-shaped sections is a strip-shaped circular surface.

6. The display device of claim 5, wherein each of the strip-shaped circular surfaces is formed by a plurality of strip-shaped planes connected in parallel with each other.

7. The display device of claim 6, wherein there is a plurality of net spots distributed on each strip-shaped plane.

8. The display device of claim 2, wherein each of the strip-shaped sections is a polygon curved surface.

9. The display device of claim 8, wherein each of the polygon curved surfaces is formed by a plurality of strip-shaped planes connected in parallel with each other.

10. The display device of claim 9, wherein there is a plurality of net spots distributed on each strip-shaped plane.

11. A light guide plate with a curved surface, the curved surface of the light guide plate with a curved surface being formed by a plurality of strip-shaped sections connected in parallel with each other, and a strip-shaped groove parallel and connected to the strip-shaped sections being formed between each two of the strip-shaped sections.
